(19) United States
(12) Patent Application Publication
(10) Pub. No.: US 2018/0036657 A1
(43) Pub. Date: Feb. 8, 2018

(54) SUSPENDED-MATTER REMOVING METHOD AND SUSPENDED-MATTER REMOVING APPARATUS

(71) Applicant: MITSUBISHI HEAVY INDUSTRIES, LTD., Tokyo (JP)

(72) Inventors: Masayuki Tabata, Tokyo (JP); Seiji Furukawa, Tokyo (JP); Katsunori Matsui, Yokohama-shi (JP); Hideo Suzuki, Tokyo (JP); Gaku Kondo, Tokyo (JP); Shigeru Yoshioka, Tokyo (JP); Masaki Ishiguro, Tokyo (JP)

(73) Assignee: MITSUBISHI HEAVY INDUSTRIES, LTD., Tokyo (JP)

(21) Appl. No.: 15/551,344

(22) PCT Filed: Feb. 20, 2015
(86) PCT No.: PCT/JP2015/054883

§ 371 Date: Aug. 16, 2017

(51) Int. Cl. B01D 24/36; B01D 35/22; C02F 3/10; B01D 29/25

(52) U.S. Cl. CPC B01D 24/36; B01D 29/25; B01D 35/22; C02F 3/10; B01D 37/02

(57) ABSTRACT

A suspended-matter removing method and a suspended-matter removing apparatus are disclosed which require no sludge treatment facility, and inexpensively provide filtrate satisfying a water quality standard. The method includes: feeding a protrusion element to a filter layer formed by filling a solid filter material, adding a protrusion to a surface of the solid filter material; after feeding of the protrusion element, determining whether or not a protrusion satisfying a preset standard has been added to the surface of the solid filter material, and when it is determined that the protrusion has been added, reducing a feeding amount of the protrusion element as compared with when adding the protrusion; and passing water to be treated containing suspended matters through the filter layer having the solid filter material added with the protrusion in a state in which the feeding amount of the protrusion element is reduced.

### TECHNICAL FIELD

The present invention relates to a suspended-matter removing method and a suspended-matter removing apparatus. The present invention particularly relates to a suspended-matter removing method and a suspended-matter removing apparatus that are used in a seawater desalination plant and a water treatment plant.

### BACKGROUND ART

In recent years, as the seawater desalination market has been expanding due to global water shortage, seawater desalination plants are being constructed. As a technology for seawater desalination, there is known a method for producing fresh water by removing salt in seawater with a reverse osmosis membrane (RO membrane). A filtration apparatus using an RO membrane performs removal of suspended matters as a pretreatment.

In order to remove suspended matters, in general, a flocculant is continuously injected into the seawater to flocculate the suspended matters. As the flocculant, iron salt is used. This metal reacts with an alkaline component in the water to generate metal hydroxide.

The metal hydroxide acts as a binder, and collision and contact of suspended matters in the seawater cause conglomeration, generating flocs. An injection amount of the flocculant is increased and decreased in accordance with an amount of suspended matters in the seawater. For example, when iron salt is used as the flocculant, the iron salt is injected so as to be 0.5 to 10 ppm as iron in the seawater.

Other methods for separating suspended matters include filter filtration, centrifugation, and filtration using a solid filter material. A method using a solid filter material is advantageous in that it is inexpensive as compared with filter filtration or centrifugation, and easy to maintain. For the solid filter material, those sized to have a diameter of 300 to 2500 μm are typically used. When suspended matters to be removed are small, the flocculant is added to water to be treated to form flocs thereby to increase the size of an object to be removed, and then the filtration is performed. Here again, the flocculant is continuously injected to the water to be treated (see PTL 1).

Continuous injection of the flocculant causes growth of the flocs, which makes it easier to capture the flocs with a downstream filter. However, the filter itself must be washed regularly to discharge flocs that have been deposited inside, to outside of the system. The flocs deposited in the filter are discharged from inside of the filter by backwashing.

### CITATION LIST

### Patent Literature

{PTL 1} Japanese Unexamined Patent Application, Publication No. 2000-202460

### SUMMARY OF INVENTION

### Technical Problem

Washing-waste water discharged from backwashing has a high turbidity, and adversely affects the environment if discharged as it is. Therefore, the washing-waste water is subject to solid-liquid separation with a dehydrator or the like, and a remaining solid content is disposed as sludge outside the system. Treatment of the sludge requires a sludge treatment facility. The method of continuously injecting a flocculant has a high environmental load.

When a large amount of a flocculant is used in filtration using a solid filter material, flocs are captured at a filter layer, and a differential pressure of the filter layer is increased. An increase in the differential pressure makes it difficult for the water to be treated to pass, deteriorating removal efficiency. In order to reduce the differential pressure, the filter layer must be backwashed. The filter immediately after backwashing has a low removal rate (capture rate) of suspended matters, and requires long time (e.g., five hours or more) until the water quality of filtrate becomes stable, causing deterioration of water quality of the filtrate.

Although various mechanisms are considered as a suspended-matter removal mechanism by filtration using a solid filter material, for example, screening, removal by an interception effect of sedimentation or the like in a stagnant pool in a void or a gap, or adhesion/adsorption (electrostatic, intermolecular force, or cohesion), they have not been fully elucidated at present. Thus, there are problems in improvement of a removal rate, and in stabilization of load fluctuation or water quality of filtrate at starting.

When paying attention to the suspended-matter removal by interception among the removal mechanisms, a passage becomes smaller as a particle diameter of the solid filter material is smaller, enabling removal of smaller suspended matters. Moreover, using a smaller solid filter material increases a specific surface area of the solid filter material, which can increase a removal rate of fine suspended matters that can be captured on a surface of the solid filter material by Brownian luck.

However, when a small solid filter material is used, a pressure loss of the filter is large, and power of a water feed pump rises, increasing an operation amount. Moreover, since an operation pressure is high, a container that stores the solid filter material is required to have a higher pressure resistance, increasing cost for the apparatus. In other words, making a solid filter material smaller to improve a removal rate is in a trade-off relation with the cost.

The present invention has been made in view of the above circumstances, and it is an object of the present invention to provide a suspended-matter removing method and a suspended-matter removing apparatus, that require no sludge treatment facility, and inexpensively provide filtrate satisfying a desired water quality standard, while suppressing an increase in a differential pressure in a filter layer.

### Solution to Problem

The inventors, as a result of intensive study, have obtained new knowledge that suspended matters of 0.1 to 10 μm are not easily removed by a conventional filtration method using a solid filter material, even when the solid filter material is made smaller. Based on this, the inventors have invented a suspended-matter removing method and a suspended-matter removing apparatus for removing suspended matters of 0.1 to 10 μm.

The present invention provides a suspended-matter removing method including the steps of, by feeding a protrusion element to a filter layer formed by filling a solid filter material, adding a protrusion to a surface of the solid filter material; after feeding of the protrusion element in the step of adding a protrusion, determining whether or not a protrusion satisfying a preset standard has been added to the surface of the solid filter material, and when it is determined that the protrusion has been added, reducing a feeding amount of the protrusion element as compared with when adding the protrusion; and passing water to be treated containing suspended matters through the filter layer having the solid filter material added with the protrusion in a state in which the feeding amount of the protrusion element is reduced.

In the invention above, the protrusion is added to the surface of the solid filter material thereby to cause a microscopic change in a flow of the water to be treated in the filter layer, causing suspended matters having a size of 0.1 μm or more to 10 μm or less to be captured. This makes it possible to improve water quality of filtrate even when the water to be treated includes many suspended matters having a size of 0.1 μm or more to 10 μm or less. A fluctuation of water quality (load fluctuation) of the water to be treated is allowed, and the water quality of the filtrate can be stabilized.

In the invention above, since the protrusion element is fed to the filter layer so as to add a protrusion to the surface of the solid filter material, the protrusion can be stably added in a short time. The filter layer formed by filling the solid filter material added with the protrusion can stably remove (capture) suspended matters at a high removal rate (capture rate) from an initial stage of the step of removing suspended matters from the water to be treated. This can shorten a starting time of the filtration apparatus as compared with a conventional one.

Reducing feeding of the protrusion element enables suppression of sludge generation. Whereas, even though the amount is small, continuation of the feeding of the protrusion element allows a protrusion to be additionally formed even when the protrusion is stripped off, or water quality of the water to be treated is deteriorated, providing stabilization of the water quality of the filtrate.

In the invention above, suspended matters are removed from the water to be treated with the feeding amount of the protrusion element reduced, which can reduce sludge-generation amount as compared with when the protrusion element is continuously fed. This suppresses an increase in a differential pressure in the filter layer, allowing a backwashing interval to be prolonged.

In one aspect of the invention above, it is preferable to stop feeding of the protrusion element in the step of reducing the feeding amount of the protrusion element.

Stopping the feeding of the protrusion element enables suppression of sludge generation, eliminating necessity of a sludge treatment facility.

In one aspect of the invention above, there may be further included a step of passing the water to be treated through the filter layer in parallel with the step of adding the protrusion. This makes it possible to add a protrusion as required while filtering the water to be treated.

In one aspect of the invention above, a step of measuring a differential pressure between a first side of the filter layer and a second side of the filter layer may be included, to feed the protrusion element within a range where the measured differential pressure is less than a predetermined value, in the step of adding the protrusion.

Excessively foaming protrusion to narrow a passage of water to be treated allows an interception effect to be enhanced, as with when a solid filter material with a small diameter is used. However, according to one aspect of the invention above, the protrusion can capture suspended matters having a size of 0.1 μm or more to 10 μm or less, without narrowing the passage to an extent allowing the enhancement of the interception effect. Keeping the differential pressure in the filter layer, which is generated by adding of the protrusion, at less than the predetermined value, enables a lower initial differential pressure, and a longer maintenance interval.

In one aspect of the invention above, there may be included a step of directly or indirectly measuring an amount of a protrusion element contained in filtrate that has come out from the filter layer in the step of adding the protrusion, and it may be determined that the protrusion has been added to the surface of the solid filter material when the measured amount of the protrusion element becomes equal to or less than a preset threshold value.

When the protrusion element is fed to the filter layer, the protrusion element adheres to the surface of the solid filter material to form a protrusion. In the step of adding the projection, a decrease in an amount of the protrusion element contained in the filtrate serves as an index indicating that the protrusion element has adhered to the surface of the solid filter material. Thus, according to the aspect described above, it is possible to add a protrusion required to capture suspended matters having a size of 0.1 μm or more to 10 μm or less.

In one aspect of the invention above, a total feeding amount of the protrusion element to the filter layer in the step of adding the protrusion may be counted, and it may be determined that the protrusion has been added to the surface of the solid filter material when the counted total feeding amount reaches a preset threshold value.

Presetting a total feeding amount of the protrusion element to the filter layer allows desired protrusion to be easily added.

In one aspect of the invention above, it is preferable to include a step of inspecting water quality of the filtrate that has come out from the filter layer in the step of passing the water to be treated. When an inspection value of the filtrate exceeds a preset threshold value, it is determined that the protrusion satisfying a preset standard has not been added to the surface of the solid filter material, and the step of adding the protrusion is performed. When the inspection value of the filtrate is equal to or less than the preset threshold value, it is determined that the protrusion satisfying the preset standard has been added to the surface of the solid filter material, and the feeding amount of the protrusion element is reduced as compared with when adding the protrusion.

Since the protrusion element forms a protrusion by adhering to the surface of the solid filter material, the protrusion may be stripped off. When the protrusion is stripped off, the stripped protrusion also becomes a suspended matter, deteriorating water quality. Additionally, when the protrusion is stripped off, a removal rate of suspended matters in the filter layer is also lowered, deteriorating water quality of the filtrate. According to the aspect described above, since the protrusion is added in accordance with the water quality of the filtrate, the water quality of the filtrate can be more stable.

In one aspect of the invention above, in the step of passing the water to be treated, it is preferable to pass the water to be treated through a coarse-particle separation part to make it to be water to be primarily treated by mainly separating suspended matters larger than 10 μm contained in the water to be treated, and then pass the water to be primarily treated through the filter layer to remove suspended matters having a size of 0.1 μm or more to 10 μm or less.

Water to be treated containing many suspended matters with a large particle diameter may cause clogging in an early stage, due to an interception effect. According to the aspect described above, since the coarse-particle separation part roughly removes suspended matters having a large particle diameter, a filtering part can remove suspended matters having a size of 0.1 μm or more to 10 μm or less with less influence of suspended matters having a large particle diameter. Thus, the water quality of the filtrate that has come out from the filtering part can be stabilized, the differential pressure in the filter layer becomes less likely to be generated, and a backwashing interval can be prolonged.

In one aspect of the invention above, a height of the protrusion is preferably 4 μm or more. This allows the protrusion to capture suspended matters having a size of 10 μm or less. When the height of the protrusion is too low, a microscopic turbulence of a flow becomes less likely to be generated, and suspended-matter particles are not transported to the solid filter material, making it difficult for suspended-matter particles to adhere.

In one aspect of the invention above, an average particle diameter of the solid filter material is preferably 300 μm or more to 2500 μm or less. This can realize the filter layer capable of providing an interception effect while suppressing the differential pressure of the filter layer.

In one aspect of the invention above, the protrusion element can be made of kaolin. In one aspect of the invention above, the protrusion element can be made of iron chloride. In one aspect of the invention above, the protrusion element can be made of high-molecular polymer.

Making the protrusion element of the above-described materials makes it possible to inexpensively form a protrusion to the surface of the solid filter material. Making the protrusion element of the above-described materials realizes the filter layer that can capture suspended-matter particles having a size of 0.1 μm or more to 10 μm or less, while hardly increasing the differential pressure of the filter layer.

When the protrusion element is made of iron chloride, in the step of reducing the feeding amount of the protrusion element, the feeding amount of the protrusion element is preferably reduced such that content of the protrusion element is less than 0.5 ppm as iron, in solution that passes the filter layer.

Although an amount of iron chloride that is injected in expectation of a flocculation effect is generally 1 ppm or more as iron, sludge generation can be suppressed even with a less injection amount than the amount in which the flocculation effect is expected, in one aspect of the invention above. This is because a protrusion is formed to the surface of the solid filter material, and the protrusion removes suspended matters. In one aspect of the invention above, even though the amount is small, continuation of feeding of the protrusion element allows a protrusion to be additionally formed even when the protrusion is stripped off, or water quality of the water to be treated is deteriorated, providing stabilization of the water quality of the filtrate.

The present invention provides a suspended-matter removing apparatus that includes a filtering part having a filter layer formed by filling a solid filter material; a water-to-be-treated feeding part that feeds water to be treated to a first side of the filtering part to pass the water to be treated through the filter layer; a protrusion-element feeding part that feeds a protrusion element to the first side of the filtering part; a determination part that, based on a preset standard, determines whether or not a protrusion has been added to a surface of the solid filter material; and a control part that, when the determination part determines that the protrusion has been added, controls the protrusion-element feeding part to reduce feeding amount of the protrusion element as compared with when it is determined that the protrusion has not been added.

In one aspect of the invention above, the control part may also control the protrusion-element feeding part to stop feeding of the protrusion element when the determination part determines that the protrusion has been added.

In one aspect of the invention above, there is included a differential-pressure measurement part that measures a differential pressure between the first side and a second side of the filtering part, and the control part can control a feeding amount of the protrusion element from the protrusion-element feeding part such that the differential pressure measured by the differential-pressure measurement part becomes less than a predetermined value.

### Advantageous Effects of Invention

A suspended-matter removing method and a suspended-matter removing apparatus according to the present invention perform filtration of water to be treated with a filter layer formed by filling a solid filter material that is added with a protrusion, thereby to inexpensively provide filtrate satisfying a water quality standard without necessity of a sludge treatment facility, while suppressing an increase in a differential pressure in the filter layer.

### BRIEF DESCRIPTION OF DRAWINGS

FIG. 1 is a schematic block diagram of a suspended-matter removing apparatus according to a first embodiment.

FIG. 2 is a schematic block diagram of a suspended-matter removing apparatus according to a second embodiment.

FIG. 3 is a schematic block diagram of a suspended-matter removing apparatus according to a third embodiment.

FIG. 4 is a schematic view explaining a passage width d₀.

FIG. 5 is a graph showing a simulation result in Study 1.

FIG. 6 is a schematic view explaining a flow of water to be treated.

FIG. 7 is a view showing a simulation result in Study 2.

FIG. 8 is a view showing a simulation result in Study 2.

FIG. 9 is a view showing a simulation result in Study 2.

FIG. 10 is a graph showing a simulation result in Study 3.

FIG. 11 is a graph showing a measurement result of a differential pressure of a filter layer in Study 4.

FIG. 12 is a graph showing a measurement result of an SDI of Tests A and B in Study 4.

FIG. 13 is a graph showing a measurement result of a differential pressure of a filtering part (filter layer) in Study 5.

FIG. 14 is a graph showing a measurement result of an SDI of filtrate that has come out from the filtering part (filter layer) in Study 5.

FIG. 15 is a graph showing a measurement result of differential pressures of a coarse-particle separation part and a filtering part (filter layer) in Study 6.

FIG. 16 is a graph showing a measurement result of an SDI of filtrate that has come out from the filtering part (filter layer) in Studies 6, 7, and 8.

FIG. 17 is a graph showing a measurement result of differential pressures of a coarse-particle separation part and a filtering part (filter layer) in Study 7.

FIG. 18 is a graph showing a measurement result of differential pressures of a coarse-particle separation part and a filtering part (filter layer) in Study 8.

### DESCRIPTION OF EMBODIMENTS

One embodiment of a suspended-matter removing method and a suspended-matter removing apparatus according to the present invention is now described below with reference to drawings.

### First Embodiment

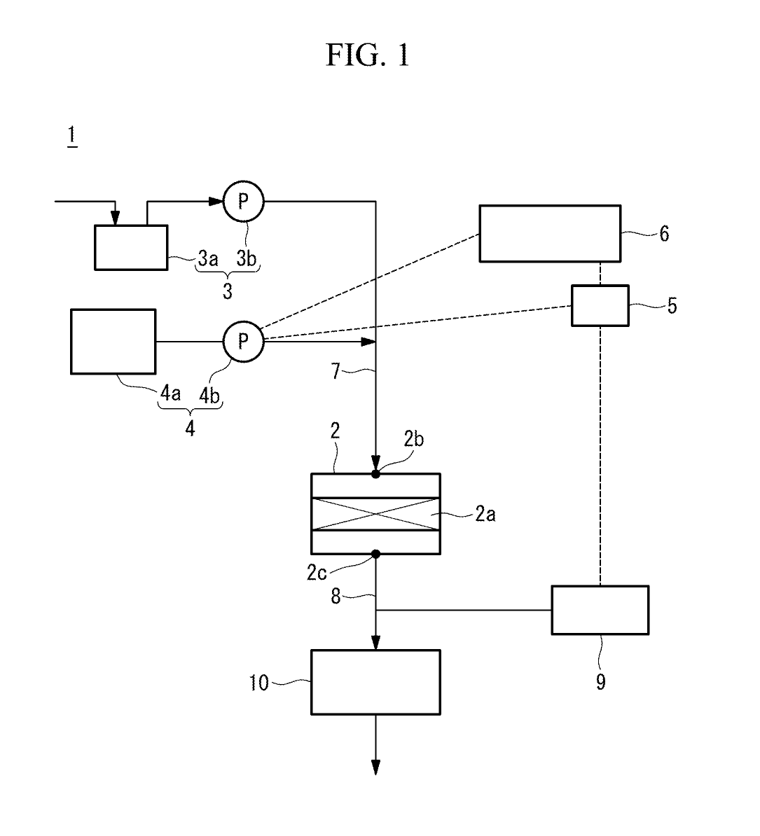

FIG. 1 is a schematic block diagram of a suspended-matter removing apparatus according to the embodiment. The suspended-matter removing apparatus 1 includes a filtering part 2, a water-to-be-treated feeding part 3, a protrusion-element feeding part 4, a determination part 5, and a control part 6.

The filtering part 2 has at least one filter layer 2a, a first opening 2b provided on a first side of the filter layer 2a, and a second opening 2c provided on a second side of the filter layer. The first opening 2b and the second opening 2c are inflow/outflow ports for liquid, of the filtering part 2. The first opening 2b is connected with a first passage 7. The second opening 2c is connected with a second passage 8.

The filter layer 2a is famed by filling a solid filter material in the filtering part. A filling amount of the solid filter material is appropriately set. One filter layer 2a is formed by a solid filter material made of one kind of material. A plurality of the filter layers 2a may be laminated in the filtering part. For example, a sand filter layer filled with sand and an anthracite filter layer formed by filling anthracite may be laminated. Solid filter materials made of different materials have different surface conditions. Combination of filter layers famed by different materials enables removal of suspended-matters with a wide range of sizes.

A solid filter material to be used is granular or fibrous. For example, the solid filter material is made of sand, anthracite, crushed activated carbon, fiber bundle, and the like. Since crushed activated carbon has an effect of removing chlorine, using crushed activated carbon as the solid filter material enables removal of chlorine contained in water to be treated, in the filtering part. This can prevent deterioration in an RO membrane, even when the RO membrane is provided at a subsequent stage.

An average particle diameter of the solid filter material is selected from 300 μm or more to 2500 μm or less. A definition of “the average particle diameter of the solid filter material” is based on AWWA B100-01 and JIS8801.

The water-to-be-treated feeding part 3 can feed water to be treated to the first side of the filtering part 2, to pass the water to be treated through the filter layer 2a. In this embodiment, the water-to-be-treated feeding part 3 is configured by a water-to-be-treated tank 3a and a first feeding means 3b. The water-to-be-treated feeding part 3 is connected to the first opening 2b of the filtering part 2 via the first passage 7. The water-to-be-treated tank 3a is a container that stores the water to be treated. The stored water to be treated is seawater, dirty water, industrial wastewater, or the like. The first feeding means 3b is a pump or the like. The first feeding means 3b can feed the water to be treated stored in the water-to-be-treated tank 3a, to filtering part 2 via the first passage 7.

The protrusion-element feeding part 4 can feed a protrusion element to the first side of the filtering part 2. In this embodiment, the protrusion-element feeding part 4 is configured by a protrusion element tank 4a and a second feeding means 4b. The protrusion-element feeding part 4 is connected to the first opening 2b of the filtering part 2 via the first passage 7, at a downstream side of the water-to-be-treated feeding part 3. The protrusion element tank 4a is a container that stores the protrusion element. The second feeding means 4b is a pump or the like. The second feeding means 4b can feed the protrusion element stored in the protrusion element tank 4a, to the filtering part 2 via the first passage 7.

The protrusion element is made of iron chloride, iron sulfate, polyaluminum chloride (PAC), aluminum sulfate, mineral, high-molecular polymer (cationic high-molecular polymer, anionic high-molecular polymer, and nonionic high-molecular polymer), inorganic pigment, and the like. The mineral is, for example, kaolin. For the cationic high-molecular polymer, polyacrylic ester-based, polymethacrylic acid ester-based, and polyacrylamide-based are suitable. As the anionic high-molecular polymer, polyacrylamide-based and polyacrylic acid-based are preferable. As the nonionic high-molecular polymer, polyacrylic ester-based, polymethacrylic acid ester-based, and polyacrylamide-based are preferable. The inorganic pigment is, for example, calcium carbonate, talc, and titanium oxide. The protrusion element may be powder or liquid. In this embodiment, the protrusion element is stored in the protrusion element tank in a solution state prepared at a predetermined concentration (protrusion forming liquid).

For example, iron chloride becomes iron hydroxide in the water, and a microfloc of the iron hydroxide adheres to the surface of the solid filter material, to form a protrusion. The microfloc may involve minute particles in the water. For example, kaolin physically adheres to the surface of the solid filter material, to form a protrusion. For example, high-molecular polymer acts as an adhesive for bonding particles contained in the water to the solid filter material, and adheres to the surface of the solid filter material along with the particles, to form a protrusion.

The protrusion element that is fed to the filter layer may be one or more kinds. For example, when kaolin and high-molecular polymer are fed to the filter layer, the kaolin physically adheres to the surface of the solid filter material, and particles contained in the water and the kaolin adhere to the surface of the solid filter material through an adhesive effect of the high-molecular polymer, to form a protrusion.

The determination part 5 can determine, based on a preset standard, whether or not a protrusion satisfying the preset standard has been added to the surface of the solid filter material. In this embodiment, the determination part 5 includes a counting means (not shown) that counts a total feeding amount of the protrusion element. For example, the counting means is connected to the second feeding means 4b. For example, the counting means can receive a power-supply ON/OFF signal of the second feeding means 4b, and count a total feeding amount of the protrusion element based on a time when the power supply of the second feeding means 4b is ON, and a concentration of the protrusion element in the protrusion forming liquid. The determination part 5 can determine, when the counted total feeding amount of the protrusion element reaches a preset threshold value, that a protrusion satisfying the preset standard has been added to the surface of the solid filter material. The determination part 5 may be incorporated into the second feeding means 4b or the control part 6.

The control part 6 can control the feeding amount of the protrusion element from the protrusion-element feeding part 4 so as to reduce the feeding amount of the protrusion element when the determination part 5 determines that a protrusion satisfying the preset standard has been added (abbreviated as a protrusion has been added). The control part 6 can control the feeding amount of the protrusion element from the protrusion-element feeding part so as to feed the protrusion element to add a protrusion to the surface of the solid filter material when the determination part 5 determines that a protrusion satisfying the preset standard has been not added (hereinafter abbreviated as a protrusion has not been added). The feeding amount of the protrusion element required for adding a protrusion to the surface of the solid filter material has been appropriately set in accordance with a kind of the protrusion element. “Reduce the feeding amount of the protrusion element” means decreasing the feeding amount of the protrusion element as compared with when adding the protrusion.

When protrusion elements, such as iron chloride and high-molecular polymer, capable of providing a flocculation effect are used, the feeding amount of the protrusion element is set to be reduced to an amount with which at least a flocculation effect cannot be expected. “Reduce the feeding amount of the protrusion element” includes stopping of the feeding amount of the protrusion element.

The control part 6 is, for example, configured by a CPU (Central Processing Unit), a RAM (Random Access Memory), a ROM (Read Only Memory), a computer-readable storage medium, and the like. Then, a series of processing for achieving various functions is, as an example, stored in a foam of a program in a storage medium or the like, and the CPU reads the program into the RAM or the like to execute information processing and arithmetic processing, thereby to achieve the various functions. It should be noted that, the program may be applied with a form such as a form that is previously installed in a ROM or another storage medium, a form provided in a state being stored in a computer-readable storage medium, or a foam that is delivered via a wired or wireless communication means. The computer-readable storage medium is a magnetic disk, a magneto-optical disk, a CD-ROM, a DVD-ROM, a semiconductor memory, or the like.

The suspended-matter removing apparatus 1 preferably includes a water-quality inspection means 9 that inspects water quality of filtrate that has come out from the second side of the filtering part. The water-quality inspection means 9 is, for example, an SDI (Silt Density Index) measuring device, a turbidimeter, a TOC meter, an SS meter, a UV meter, a COD meter, and the like. In FIG. 1, the water-quality inspection means 9 is connected to the second passage and the determination part 5. The water-quality inspection means 9 can inspect the water quality of the filtrate discharged from the filtering part 2 to the second passage, and output an inspection result to the determination part 5. The determination part 5 can determine that a protrusion has not been added when the inspection value obtained from the water-quality inspection means 9 exceeds a preset threshold value, and determine that the protrusion has been added when the inspection value becomes equal to or less than the threshold value. The threshold value is appropriately set in accordance with an item of water quality to be inspected.

The suspended-matter removing apparatus 1 may include, at a downstream side of the filtering part 2, a reverse-osmosis-membrane treatment part 10, an electrodialysis part (not shown), an evaporator (not shown) or the like. The reverse-osmosis-membrane treatment part 10 is, for example, a reverse-osmosis-membrane treatment apparatus having a plurality of reverse-osmosis-membrane elements in a container. The reverse-osmosis-membrane treatment apparatus can divide the water to be treated (filtrate) that has passed through the filtering part 2, into fresh water and concentrated water containing ions, salt or the like, with a reverse osmosis membrane (RO membrane).

The suspended-matter removing apparatus 1 may include a backwashing means (not shown) for backwashing the filter layer 2a. The backwashing means is provided to the filtering part 2 such that washing liquid flows from the second side toward the first side of the filtering part 2a. The washing liquid is supplied to the filtering part 2 by a liquid supplying means such as a pump.

Next, a suspended-matter removing method according to the embodiment is described. The suspended-matter removing method according to the embodiment includes the following steps (S1) to (S3).

(S1) A step of adding a protrusion

(S2) A step of reducing a feeding amount of the protrusion element as compared with when adding a protrusion

(S3) A step of passing water to be treated containing suspended matters, through the filter layer having a solid filter material added with the protrusion

In the step of adding a protrusion (S1), a protrusion element is fed to the filter layer 2a, to add a protrusion to the surface of the solid filter material.

The protrusion element is made of iron chloride, iron sulfate, polyaluminum chloride (PAC), aluminum sulfate, mineral, high-molecular polymer (cationic high-molecular polymer, anionic high-molecular polymer, and nonionic high-molecular polymer), inorganic pigment, and the like. The mineral is, for example, kaolin. For the cationic high-molecular polymer, polyacrylic ester-based, polymethacrylic acid ester-based, and polyacrylamide-based are suitable. As the anionic high-molecular polymer, polyacrylamide-based and polyacrylic acid-based are preferable. As the nonionic high-molecular polymer, polyacrylic ester-based, polymethacrylic acid ester-based, and polyacrylamide-based are preferable. The inorganic pigment is, for example, calcium carbonate, talc, and titanium oxide.

The protrusion element adheres to the surface of the solid filter material to form a protrusion itself, or bonds particles in water to the solid filter material. For example, iron chloride becomes iron hydroxide in the water, and a microfloc of the iron hydroxide adheres to the surface of the solid filter material, to form a protrusion. The microfloc may involve minute particles in the water. For example, kaolin physically adheres to the surface of the solid filter material, to form a protrusion. For example, high-molecular polymer acts as an adhesive for bonding particles contained in the water to the solid filter material, and adheres to the surface of the solid filter material along with the particles, to form a protrusion.

The protrusion element that is fed to the filter layer may be one or more kinds. For example, when kaolin and high-molecular polymer are fed to the filter layer, the kaolin physically adheres to the surface of the solid filter material, and particles contained in the water and the kaolin adhere to the surface of the solid filter material through an adhesive effect of the high-molecular polymer, to form a protrusion.

The protrusion element may be powder or suspension containing minute particles. In this embodiment, the protrusion element is fed in a solution state containing the protrusion element (protrusion foaming liquid). A solvent of the protrusion forming liquid is industrial water, seawater, clear water or the like. When the protrusion element is made of high-molecular polymer, the protrusion forming liquid is preferably prepared with solution containing particles (e.g. seawater).

A concentration of the protrusion element in the protrusion forming liquid is set such that a predetermined amount of the protrusion element is fed when the protrusion foaming liquid is passed through the filter layer 2a. The feeding amount of the protrusion element may be appropriately set in accordance with a kind of the protrusion element and a component of the water to be treated.

A protrusion is added by passing the protrusion forming liquid through from the first side to the second side of the filter layer 2a. This allows a protrusion to be added to the surface of the solid filter material. A filtering speed of the protrusion forming liquid is preferably same as a filtering speed of the water to be treated. The filtering speed can be adjusted by the first feeding means 3b or the second feeding means 4b. When the filtering speed is adjusted by the first feeding means 3b, the water to be treated is passed through the filter layer 2a, in parallel with the step of adding a protrusion (S1).

After the protrusion element is fed to the filter layer 2a to add a protrusion to the surface of the solid filter material, the feeding amount of the protrusion element is reduced as compared with when the protrusion is added (S2).

Based on a preset standard, it is determined whether or not a protrusion has been added to the surface of the solid filter material. “Standard” can be set by performing a preliminary test or the like. In the preliminary test, the water quality of the filtrate is inspected, for example, by passing the protrusion forming liquid containing the protrusion element with an optional concentration through the filter layer. The feeding amount of the protrusion element, at a time when the inspection value becomes a desired value, is set to be a threshold value (standard) of the feeding amount of the protrusion element for adding a required amount of the protrusion to the solid filter material.

In the step (S2), a total feeding amount of the protrusion element to the filter layer 2a in the step of adding a protrusion (S1) is counted, and it is determined that a protrusion satisfying a preset standard has been added to the surface of the solid filter material when the counted total feeding amount reaches a preset threshold value. When it is determined that the protrusion has been added, the feeding amount of the protrusion element is reduced. The extent of the reduction of the feeding amount of the protrusion element may be appropriately set in accordance with a kind of the protrusion element. When there is used a protrusion application that can provide a flocculation effect in accordance with a feeding amount, the feeding amount of the protrusion element after being reduced is an amount with which the flocculation effect cannot be expected even if added to the water to be treated. For example, when the protrusion element is made of iron chloride, it is reduced to about less than 0.5 ppm as iron (Fe) with respect to an amount of solution to be passed through the filter layer 2a. In the step (S2), the feeding amount of the protrusion element may be set to be zero, by stopping the feeding of the protrusion element.

Water to be treated containing suspended matters is passed through the filter layer 2a (S3), with the feeding amount of the protrusion element reduced (or stopped). Here, a protrusion has been added to the surface of the solid filter material filled in the filter layer 2a.

In the step of passing the water to be treated containing suspended matters (S3), it is preferable to inspect water quality of the filtrate that has come out from the filter layer 2a. When an inspection value of the filtrate exceeds a preset threshold value, the protrusion element is again fed to the filter layer to add a protrusion to the surface of the solid filter material (S2′). Then, the feeding of the protrusion element is reduced (or stopped) when the inspection value of the filtrate becomes equal to or less than the preset threshold value (S3′).

In (S3), “water-quality inspection” is performed with an SDI measuring device, a turbidimeter, a TOC meter, an SS meter, a UV meter, a COD meter and the like. The threshold value is set in accordance with an inspection method. For example, when the inspection method is an SDI, the threshold value may be SDI<4 or the like.

When the protrusion element is fed to the filter layer filled with the solid filter material, the protrusion element comes into contact with the solid filter material to add a protrusion to the surface of the solid filter material. At a removal of suspended matters from the water to be treated, passing the protrusion element through the filter layer at an early stage allows the protrusion to be added to the surface of the solid filter material in a short time. The filter layer famed by filling the solid filter material added with the protrusion can stably remove suspended matters at a high removal rate from an initial stage of the step of removing suspended matters from the water to be treated. This can shorten a starting time of the suspended-matter removing apparatus as compared with conventional ones. Additionally, since the filter layer filled with the solid filter material added with the protrusion can capture suspended matters of 0.1 um or more to 10 μm or less, it is possible to improve the water quality of the filtrate even when the water to be treated includes many suspended matters having a size of 0.1 μm or more to 10 μm or less. Namely, it makes it possible to cope with fluctuation in water quality of the water to be treated. Adding a protrusion to the surface of the solid filter material of 300 μm or more to 2500 μm or less provides a suspended-matter removal effect more than an interception effect.

Reducing the feeding amount of the protrusion element enables suppression of sludge generation. This suppresses an increase in a differential pressure in the filter layer, which can prolong a backwashing interval and eliminate necessity of a sludge treatment facility.

Even when the feeding of the protrusion element is stopped, water quality of the filtrate in the step (S3) can be stabilized until the protrusion is stripped off, as long as the protrusion has once been added to the surface of the solid filter material. The protrusion can be replenished by continuing the feeding of the protrusion element, even though the amount is small. Therefore, even if the protrusion is stripped off, stability of the water quality of the filtrate can be maintained. Moreover, when the feeding of the protrusion element is stopped, an amount of protrusion-element usage can be lowered, enabling reduction of treatment cost.

Inspecting the water quality of the filtrate in the step (S3) allows a protrusion to be added again to the surface of the solid filter material when the water quality of the filtrate is degraded. This can stabilize the water quality of the filtrate even more.

Although, in the step of adding a protrusion (S1) in the embodiment, a protrusion is added after the solid filter material fills the filtering part, a similar effect can be obtained by foaming the filter layer by filling the filtering part with the solid filter material, that has been added with a protrusion in another container.

### Second Embodiment

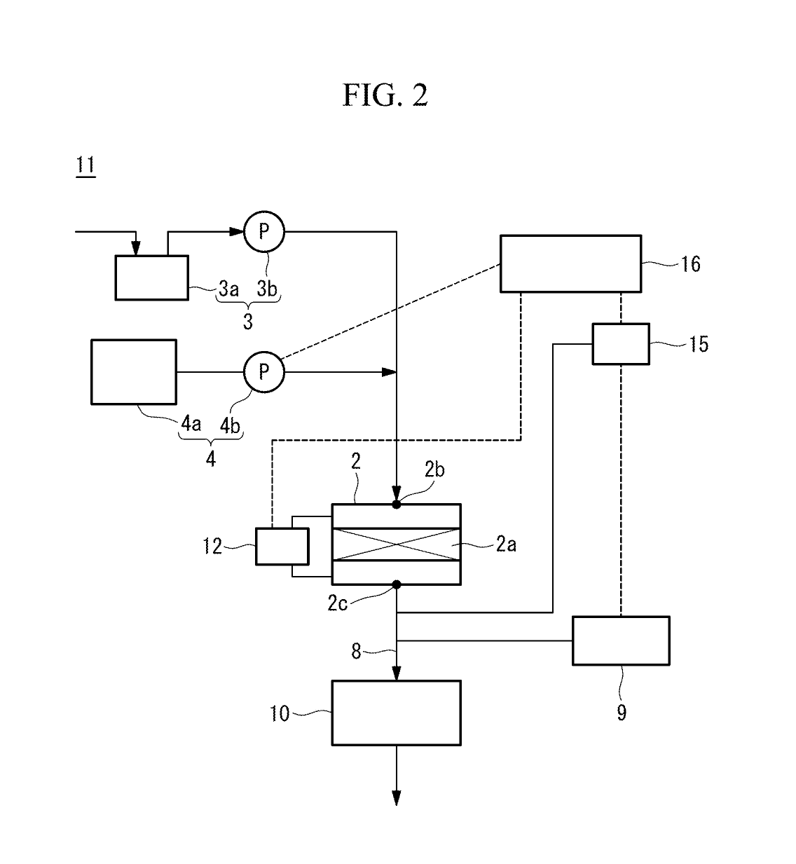

FIG. 2 is a schematic block diagram of a suspended-matter removing apparatus according to the embodiment. The suspended-matter removing apparatus 11 includes a filtering part 2, a water-to-be-treated feeding part 3, a protrusion-element feeding part 4, a differential-pressure measurement part 12, a determination part 15, and a control part 16. The filtering part 2, the water-to-be-treated feeding part 3, and the protrusion-element feeding part 4 have a same configuration as the first embodiment. The suspended-matter removing apparatus 11 may include a water-quality inspection means 9, as with the first embodiment.

The differential-pressure measurement part 12 can measure a differential pressure between a first side (first opening side) and a second side (second opening side) of a filter layer 2a (the filtering part 2). In this embodiment, the differential-pressure measurement part 12 is connected to the first side and the second side of the filtering part 2. The differential-pressure measurement part 12 is, for example, a water pressure meter. The water pressure meter detects pressures on the first side and the second side of the filtering part 2, to measure the differential pressure.

The determination part 15 can determine, based on a preset standard, whether or not a protrusion has been added to a surface of a solid filter material. In this embodiment, the determination part 15 includes a protrusion-element-amount measurement means (not shown) that directly or indirectly measures an amount of the protrusion element contained in the filtrate that has come out from the second side (second opening side) of the filtering part 2. The protrusion-element-amount measurement means may be sufficient if it can directly or indirectly measure the amount of the protrusion element. For example, when the protrusion element is made of iron chloride, a water-quality analyzer capable of monitoring an iron concentration can be used as the protrusion-element-amount measurement means, to directly measure the protrusion element. For example, using an SDI measuring device as the protrusion-element-amount measurement means enables indirect measurement of the protrusion element. For example, when the protrusion element is made of kaolin, using a turbidimeter as the protrusion-element-amount measurement means enables indirect measurement of the protrusion element.

When the protrusion element is indirectly measured, the protrusion-element-amount measurement means can also serve as the water-quality inspection means. In this embodiment, the protrusion-element-amount measurement means is an SDI measuring device, which also serves as the water-quality inspection means.

The determination part 15 can determine that a protrusion has been added to the surface of the solid filter material when a measured value of the protrusion-element-amount measurement means becomes equal to or less than a preset threshold value. The determination part 15 may also determine that a protrusion has been added to the surface of the solid filter material, when it is confirmed that the measured value becomes equal to or less than a preset threshold value and has been maintained in the state for a certain time. The determination part 15 may be incorporated into the control part 16.

The control part 16 is connected to the differential-pressure measurement part 12, the determination part 15, and a second feeding means 4b. The control part 16 can control a feeding amount of the protrusion element from the protrusion-element feeding part 4 such that the differential pressure measured by the differential-pressure measurement part 12 becomes less than a predetermined value. The control part 16 receives a differential pressure value measured by the differential-pressure measurement part 12, and automatically controls the feeding amount of the protrusion element from the protrusion-element feeding part 4 such that the differential pressure is maintained at less than the predetermined value.

The control part 16 can control the protrusion-element feeding part 4 to feed the protrusion element to add a protrusion to the surface of the solid filter material when the determination part 15 determines that a protrusion has not been added, and to reduce the feeding amount of the protrusion element when the determination part 15 determines that a protrusion has been added.

The suspended-matter removing apparatus 11 may include, at a downstream side of the filtering part 2, a reverse-osmosis-membrane treatment part 10, an electrodialysis part (not shown), an evaporator (not shown) or the like. The suspended-matter removing apparatus 11 may include a backwashing means (not shown) for backwashing the filter layer 2a.

The suspended-matter removing method according to the embodiment includes the following steps (S11) to (S14):

(S11) A step of adding a protrusion

(S12) A step of measuring the differential pressure between the first side of the filter layer and the second side of the filter layer

(S13) A step of reducing a feeding amount of the protrusion element as compared with when adding a protrusion

(S14) A step of passing water to be treated containing suspended matters, through the filter layer having a solid filter material added with the protrusion

In the step of adding a protrusion (S11), the protrusion element is fed to the filter layer 2a to add a protrusion to the surface of the solid filter material. A procedure for feeding the protrusion element to the filter layer 2a is same as that of the first embodiment.

In this embodiment, while the protrusion element is being fed to the filter layer 2a, the differential pressure between the first side and the second side of the filter layer 2a is measured (S12). In the step of adding a protrusion (S11), the protrusion element is fed to the filter layer 2a in a range that the differential pressure measured at (S12) is less than a predetermined value. When the measured differential pressure becomes equal to or more than the predetermined value, the feeding of the protrusion element is immediately stopped. The “predetermined value” may be set based on an allowable pressure of the filtering part, or may previously be set by performing a preliminary test or the like. In the preliminary test, the differential pressure of the filter layer is measured, and water quality of filtrate is inspected, for example, by passing the protrusion foaming liquid containing the protrusion element with an optional concentration through the filter layer. The differential pressure of the filter layer when an inspection value of the filtrate becomes a desired value may be set to be a predetermined value.

In the step (S13), an amount of the protrusion element contained in the filtrate that has come out from the filter layer 2a in the step of adding a protrusion (S11), is directly or indirectly measured. When the measured amount of the protrusion element becomes equal to or less than a preset threshold value, it is determined that a protrusion has been added to the surface of the solid filter material. When it is determined that the protrusion has been added, the feeding amount of the protrusion element is reduced (or stopped), as with the step (S2) in the first embodiment.

Water to be treated containing suspended matters is passed through the filter layer 2a (S14), with the feeding amount of the protrusion element reduced (or stopped), as with the step (S3) in the first embodiment.

In the step of passing the water to be treated containing suspended matters (S14), it is preferable to inspect the water quality of the filtrate that has come out from the filter layer, as with the step (S3) in the first embodiment.

According to the embodiment, measuring the differential pressure between the first side and the second side of the filter layer enables reliable suppression of an increase in the differential pressure due to formation of a protrusion.

According to the embodiment, measuring the amount of the protrusion element in the filtrate that comes out when the protrusion element is fed enables confirmation that the protrusion element has not come out to the filtrate. Thereby, in an indirect way, it can be confirmed that a protrusion has been formed on the surface of the solid filter material.

### Third Embodiment

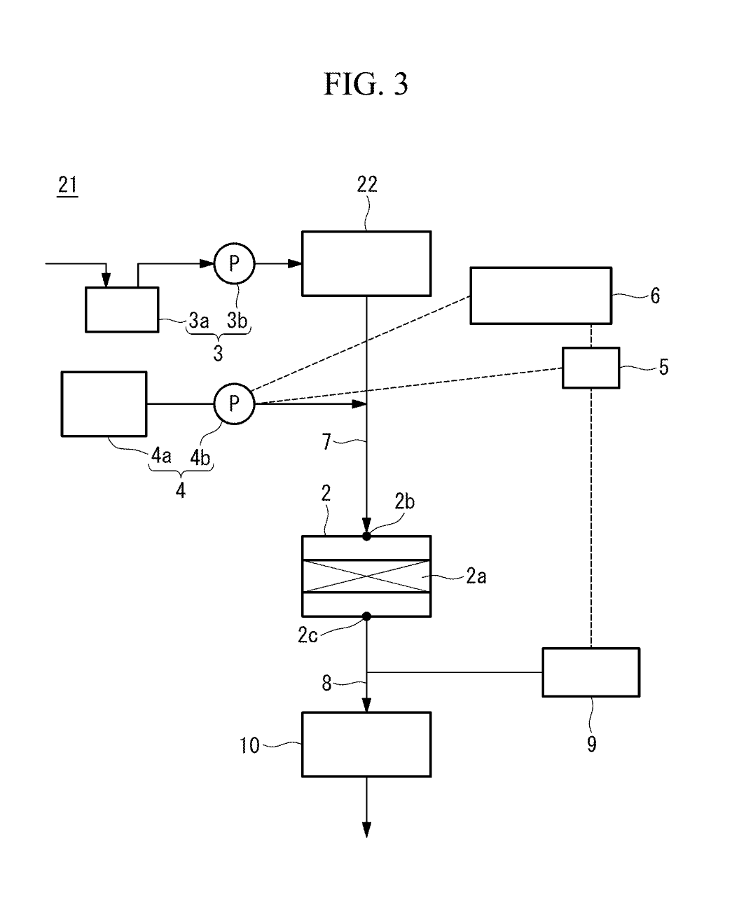

FIG. 3 is a schematic block diagram of a suspended-matter removing apparatus according to the embodiment. The suspended-matter removing apparatus 21 has a same configuration as that of the first embodiment except for including a coarse-particle separation part 22.

The coarse-particle separation part 22 is provided between a water-to-be-treated feeding part 3 and a filtering part 2, in a preceding stage of a protrusion-element feeding part 4. The coarse-particle separation part 22 mainly separates suspended matters larger than 10 μm contained in water to be treated. The coarse-particle separation part 22 is a sand filtration apparatus, a floatation-separation apparatus, or the like. When the coarse-particle separation part 22 is a sand filtration apparatus, the water to be treated may be passed without addition of a flocculant. When the coarse-particle separation part 22 is a floatation-separation apparatus, solid-liquid separation is performed by bonding/floating SS (sludge or floating matter) with a large amount of bubbles (micro-air) generated from water to be treated mixed with saturated pressurized water.

In this embodiment, by passing water to be treated through the coarse-particle separation part 22, suspended matters larger than 10 μm are mainly separated from the water to be treated, to make it water to be primarily treated. Then, the water to be primarily treated is guided to the filter layer, and suspended matters having a size of 0.1 μm or more to 10 μm or less are removed.

The protrusion element can be fed to the filter layer 2a, at a same time as the guiding of the water to be primarily treated to the filter layer. The protrusion element may be fed to the filter layer 2a before the guiding of the water to be primarily treated to the filter layer 2a. In either case, a protrusion is added to the surface of the solid filter material in accordance with the first embodiment or the second embodiment, and then the feeding amount of the protrusion element is reduced (or stopped).

According to the embodiment, by separating the rough removal of suspended matters with a large particle diameter in the water to be treated, and the removal of suspended matters with a medium particle diameter of 0.1 μm or more to 10 μm or less, an increase in a differential pressure due to clogging or the like in the filter layer can be suppressed. This makes it possible to stabilize the water quality of the filtrate of the filter layer, and reduce a backwashing frequency of the filter layer.

Next, a basis for the first to third embodiments and a working effect are described.

### (Study 1)

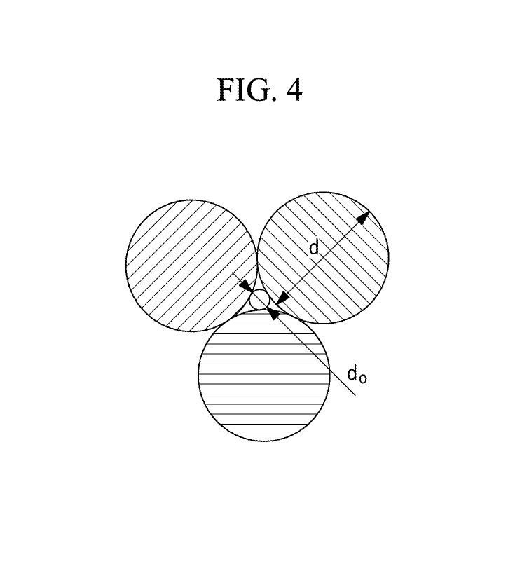

A study was made, through a simulation, regarding a relationship between a capture rate and a size of suspended matters captured in a filter layer (captured-particle diameter) at a time when water to be treated containing suspended matters is passed through a filter layer formed by filling a solid filter material. A balance equation in the filtration, in consideration of diffusion by Brownian motion and an interception effect, was made for execution of the simulation. A passage width d₀ is equivalent to a diameter of a small circle that is in a region surrounded by three solid filter materials in contact with each other, and is in contact with the three solid filter materials (see FIG. 4). Diffusion of suspended matters due to turbulence of a flow generated by unevenness on a surface is not considered. The solid filter materials had a spherical shape, and particle diameters of 100 μm, 300 μm (a minimum diameter of sand used industrially for sand filtration), and 1200 μm (a maximum diameter of sand used industrially for sand filtration). A filtering speed was 25 m/h (equivalent to cross-sectional porosity of 50% of a sand filter column at a superficial velocity 12.5 m/h). In this simulation, the passage width d₀ was same as the particle diameter of the solid filter material.

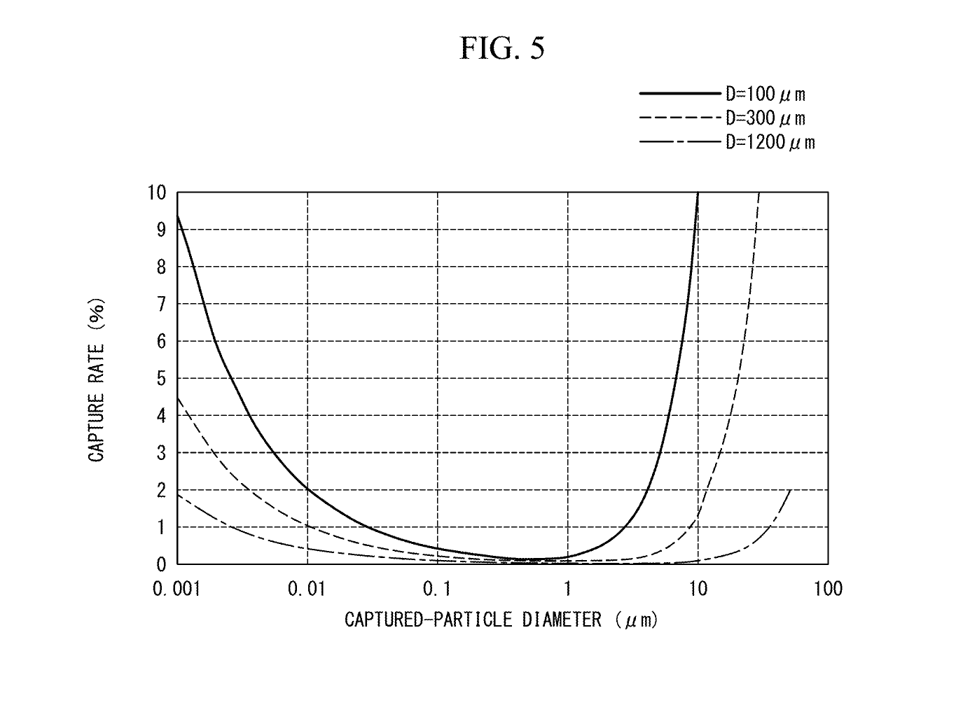

A simulation result is shown in FIG. 5. In this figure, the horizontal axis is the captured-particle diameter (μm), and the vertical axis is the capture rate (%). According to FIG. 5, as the solid filter material is smaller, the capture rate of suspended matters having a size about 10 μm became higher. However, it was confirmed that suspended matters having a size of 0.1 μm to 5 μm can be hardly captured, even when there was used a solid filter material having a size of a minimum diameter of sand used industrially for sand filtration.

A result of (Study 1) above shows that filtration using the solid filter material can hardly remove suspended matters of 0.1 μm or more to 10 μm or less. This result suggests that, conventionally, as water to be treated contained more suspended matters of 0.1 μm or more to 10 μm or less, water quality of the filtrate was further degraded, even when a same solid filter material was used for the filtration.

Thus, the inventors have concluded that, it is possible to cope with load fluctuation and stabilize the water quality of the filtrate, by removing suspended matters having a size of 0.1 μm or more to 10 μm or less. In conventional filtration using a solid filter material, the reason why suspended matters having a size of 0.1 μm or more to 10 μm or less are not removed is considered as follows.

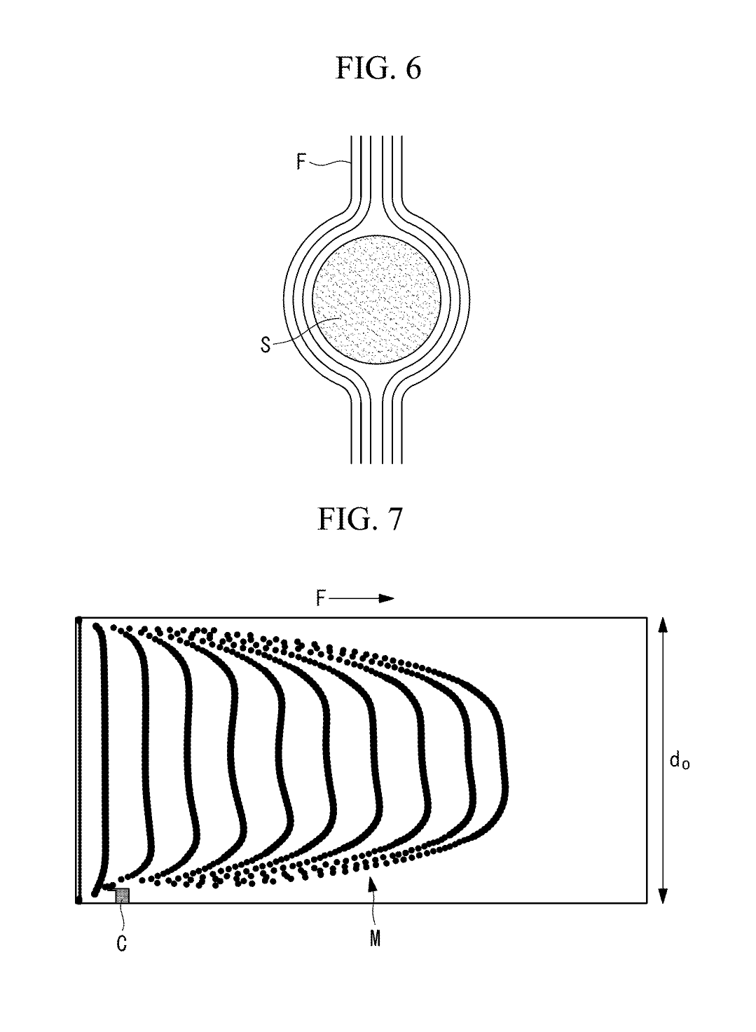

FIG. 6 shows a schematic view of a flow of water to be treated when the water to be treated is passed through the filter layer formed by filling a solid filter material. In this figure, a symbol S represents a solid filter material, and lines F extending in a vertical direction in the figure represent stream lines of the water to be treated. The water to be treated flowing in the filter layer is typically in a laminar flow state as shown in FIG. 6. It is known that, in the laminar flow state, a flow rate of the water to be treated becomes lower as closer to a surface of the solid filter material, and there is a region where the flow rate becomes substantially zero (blocking-layer region) on the surface of the solid filter material.

When the water to be treated is passed through the filter layer famed by filling the solid filter material, coarse suspended matters contained in the water to be treated cannot be passed through a gap of the solid filter material, and are captured. Even among suspended matters having a size capable of being passed through a gap of the solid filter material of the solid filter material, relatively larger suspended matters may come out from the laminar flow by the law of inertia, and collide with the solid filter material to be captured. In the suspended matters contained in the water to be treated, fine suspended matters (colloidal particles with a diameter of less than 0.1 μm) may be captured by the solid filter material due to diffusion by Brownian motion.

Whereas, among the suspended matters contained in the water to be treated, medium sized suspended matters (particles with a diameter of 0.1 μm or more to 10 μm or less) cannot come out of the laminar flow by the law of inertia or the like, and are passed through the filter layer with the laminar flow.

Based on the consideration above, a study was made regarding a method for intentionally removing medium sized suspended matters (particles with a particle diameter of 0.1 μm or more to 10 μm or less) from the laminar flow.

### (Study 2)

A study was made, through a simulation, regarding a behavior of suspended matters when water to be treated containing suspended matters is passed through a filter layer famed by filling a solid filter material added with a protrusion. The simulation was performed by using the Lattice Boltzmann Method (method for analyzing a fluid flow by using the molecular kinetic theory, and movement of suspended matters by using a motion equation). Diffusion by Brownian motion is not considered. A passage width d₀ was 600 μm, which was equivalent to a diameter of the solid filter material, a length of the passage was 1.5 mm, and a flow rate was 25 m/h (equivalent to cross-sectional porosity of 50% of a sand filter column at a superficial velocity 12.5 m/h). It was assumed that there was a protrusion with a height of 60 μm and a width of 60 μm on a surface of the solid filter material, and particle diameters of suspended matters were 1 μm (suspended matter S1) and 5 μm (suspended matter S2). In this condition, there is no interception effect from the sizes of suspended matters, the size of protrusion, and the passage width.

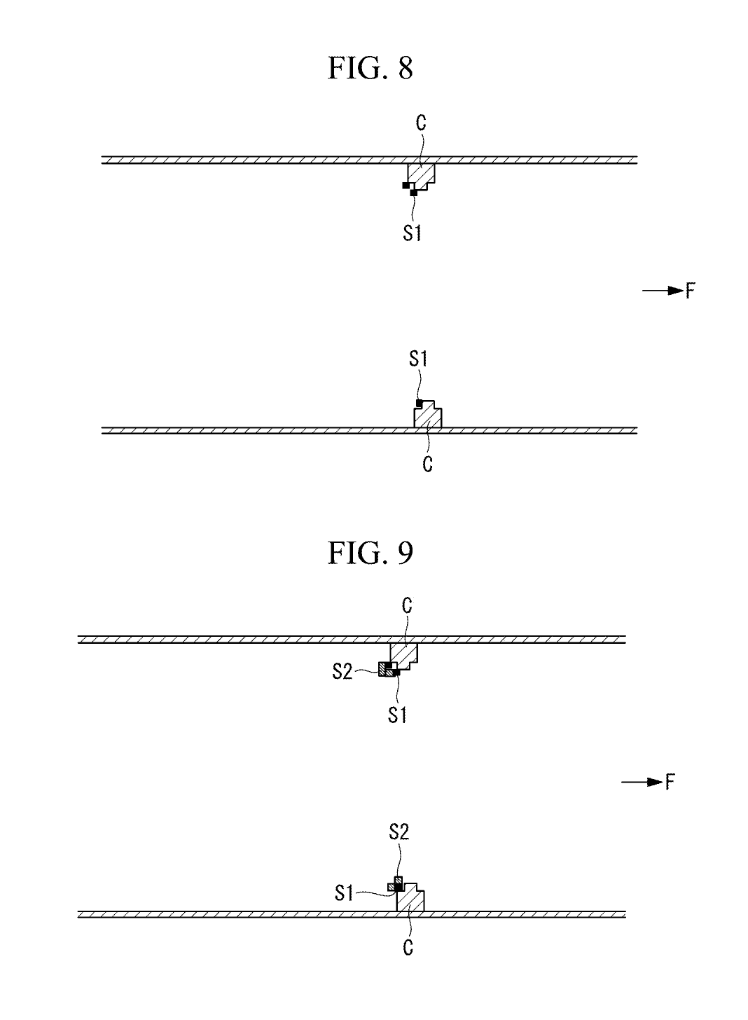

A simulation result is shown in FIGS. 7 to 9. In FIGS. 7 to 9, a vertical direction in the figure is a passage width d₀, and the water to be treated flows from left to right in the figure. FIG. 7 is a view showing a flow of suspended matters. FIG. 8 is a view illustrating a state of protrusions in an early stage of passing of the water to be treated, and FIG. 9 is a view illustrating a state of protrusions in a late stage of passing of the water to be treated.

According to FIG. 7, it could be confirmed that a presence of protrusions C caused a microscopic change in a flow direction of suspended matters M. Accordingly, it was confirmed that medium sized suspended matters came out of a laminar flow, and the medium sized suspended matters out of the laminar flow became easy to enter a blocking region, so that a capture rate of the medium sized suspended matters could be increased.

According to FIGS. 8 and 9, it was confirmed that the suspended matters M adhered to the protrusions C when the water to be treated was passed through the filter layer formed by filling the solid filter material formed with a protrusion on a surface. A position where the suspended matters M adhered was a corner facing an upstream side of a passing direction of the water to be treated. It was confirmed that suspended matters adhered to protrusions in the early stage of passing water (FIG. 8), and other suspended matters adhered around the suspended matters, that had adhered to the protrusions in the early stage of passing water, as a core, in the late stage of passing water (FIG. 9), so that the protrusions grown.

Although not illustrated, when the water to be treated was passed through a filter layer filled with a solid filter material not formed with a protrusion on a surface, no suspended matter adhered to the surface of the solid filter material.

A result of (Study 2) above suggests that, by feeding the protrusion element to the filter layer to add a protrusion satisfying a preset standard, suspended matters contained in water to be treated adhere to the protrusion, and thereby the protrusion can be grown, even when the feeding amount of the protrusion element is reduced or stopped afterward.

### (Study 3)

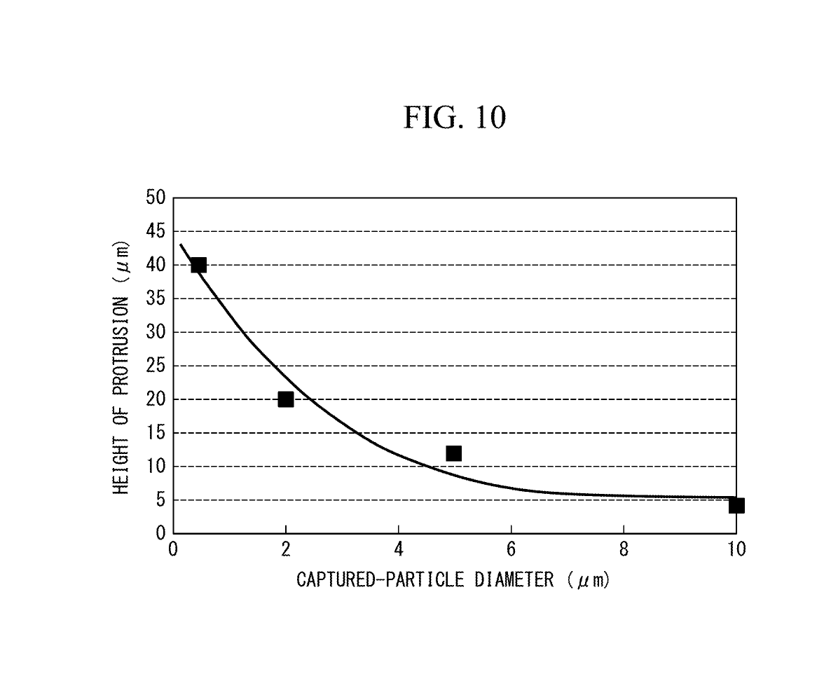

A study was made, by using the Lattice Boltzmann Method, regarding a minimum size of a protrusion required for adhesion of suspended matters of 0.45 μm (an average pore diameter of a filter for an SDI measurement) to 10 μm in seawater, on a surface of the solid filter material. Diffusion by Brownian motion is not considered. The protrusion is rectangular, and a vertical length from the surface of the solid filter material to the highest portion of the protrusion was defined as a height. Particle diameters of suspended matters were 0.45 μm, 2 μm, 5 μm, and 10 μm, and a calculation was performed for each of the particle diameters. A passage width d₀ was 600 μm, which was equivalent to a diameter of the solid filter material, a length of the passage was 1200 μm, and a flow rate was 0.006 m/s (a value equivalent to cross-sectional porosity of 50% of a sand filter column at a superficial velocity 10.8 m/h). A simulation result is shown in FIG. 10. In this figure, the horizontal axis is the captured-particle diameter (μm), and the vertical axis is the height of a protrusion (μm).

According to FIG. 10, as a size of the protrusion is larger, small suspended matters could be captured more. Placing a rectangular body (protrusion) of 4 μm enabled removal of suspended matters of 10 μm. According to FIG. 10, removal of suspended matters of 0.45 μm required a rectangle (protrusion) with a height of 40 μm.

### (Study 4)

### <Test A>

Protrusion forming liquid containing a protrusion element was passed through a filter layer famed by filling a solid filter material for three hours, to add a protrusion to a surface of the solid filter material. Then, passing of the protrusion forming liquid was stopped, and in that state, water to be treated was passed through the filter layer for three hours. A filtering speed was 10 m/h.

A filter column (column diameter 5 cm) was formed in a three-layered structure of an anthracite filter layer, a sand filter layer, and a gravel filter layer. The anthracite filter layer, the sand filter layer, and the gravel filter layer are sequentially arranged from an upstream side of the passing direction of the water to be treated. The anthracite filter layer is a filter layer famed by filling anthracite with an average particle diameter of 700 μm. A length of the anthracite filter layer is 200 mm. The sand filter layer is a filter layer formed by filling sand with an average particle diameter of 475 μm. A length of the sand filter layer is 500 mm. The gravel filter layer is a filter layer formed by filling gravel with an average particle diameter of 2000 μm. A length of the gravel filter layer is 100 mm.

The protrusion element was made of iron chloride (FeCl₃: Wako Pure Chemical Industries, Ltd.). Iron chloride reacts with an alkaline component in water to generate iron hydroxide, as formula (1) below. This iron hydroxide was presumed to adhere to the filter material to form a protrusion.

FeCl₃+3HCO₃⁻=Fe(OH)₃+3CO₂+3Cl⁻ (1)

Seawater was used as the water to be treated. An SDI of the seawater before passing was 6.14. Protrusion forming liquid containing the protrusion element was prepared, and the protrusion forming liquid was passed through the filter layer along with the water to be treated. A concentration of the protrusion element in the protrusion forming liquid was set so as to cause an Fe-concentration of 1 ppm with respect to an amount of passing water.

During the passing of the water to be treated, a differential pressure of the filter layer was measured by a differential-pressure measuring device. Additionally, an Fe-concentration and an SDI of liquid (filtrate) that has passed the filter layer were continuously measured. The Fe-concentration was measured by a 2,4,6-tris-2-pyridyl-1,3,5-triazine absorptiometric method (abbreviated as TPTZ absorptiometric method) described in JIS B8224.

The SDI is obtained by the following formula (2) based on a time required for filtration/collection at 206 kPa, by using a filter with a diameter of 47 mm and an average pore diameter of 0.45 μm.

SDI_{Tm}=(1−Δt₁/Δt₂)×100/Tm (2)

Δt₁: A time (sec) required for filtration/collection of initial 500 ml.

Δt₂: A time (sec) required for filtration/collection of 500 ml after Tm minutes.

Tm: A time from the t₁ filtration/collection starting time to the t₂ filtration/collection starting time (normally 15 minutes).

An upper limit of the SDI index is 6.67. Since the SDI is decreased, it is suggested that a ratio of suspended-matter particles larger than 0.45 μm is decreased.

### <Test B>

For comparison, only seawater was passed without passing of the protrusion forming liquid through the filter layer, and the measurement was performed as with Test A.

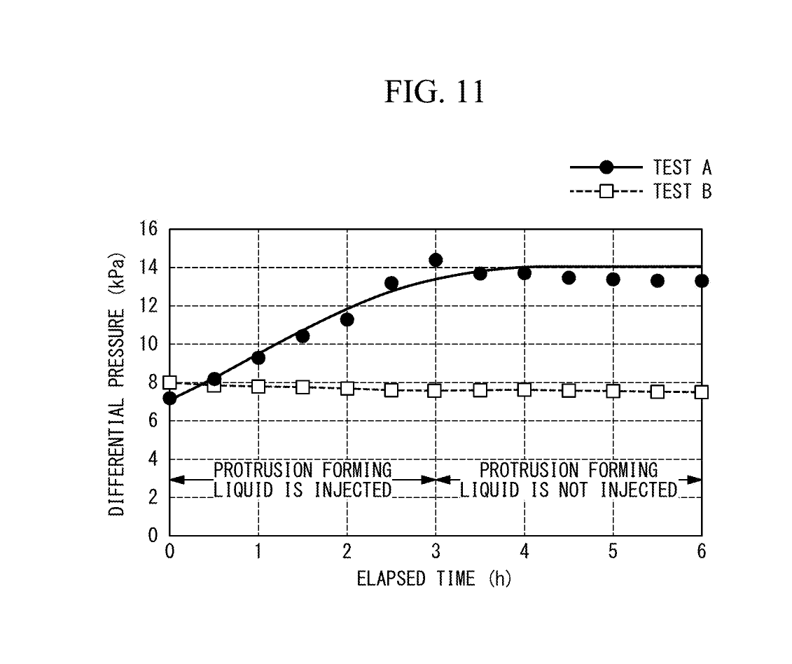

FIG. 11 shows a measurement result of a differential pressure of the filter layer. In this figure, the horizontal axis is an elapsed time (h), and the vertical axis is the differential pressure (kPa) of the filter layer. According to FIG. 11, by passing the protrusion foaming liquid containing iron hydroxide, the differential pressure of the filter layer was slightly increased in Test A, but an increase in the differential pressure was not observed after the passing of the protrusion forming liquid was stopped. In Test B (a case without passing of protrusion foaming liquid), a change in a differential pressure of the filter layer was hardly observed within the same period of time.

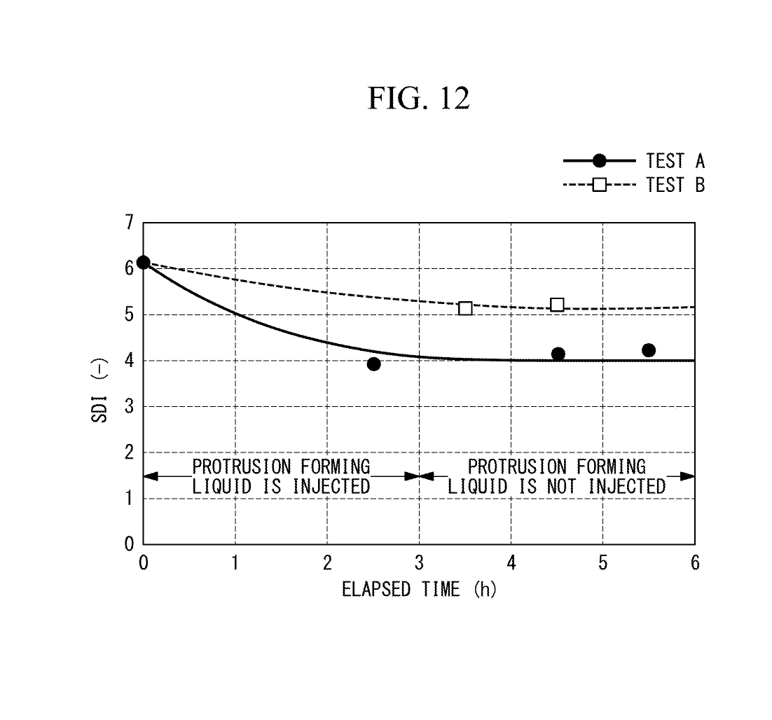

FIG. 12 shows a measurement result of an SDI of Tests A and B. In this figure, the horizontal axis is an elapsed time (h), and the vertical axis is the SDI (−).

According to FIG. 12, the SDI of the filtrate was decreased to about 4 after two to three hours of passing in Test A. Even after the passing of the protrusion foaming liquid was stopped, the SDI of the filtrate was maintained at about 4.

Although not shown in FIG. 12, an Fe-concentration of the filtrate reached 1 μg/L (detection lower limit) after two hours of the passing in Test A. This shows that the iron hydroxide contained in the protrusion forming liquid remains in the filter layer. After the passing of the protrusion forming liquid was stopped, the Fe-concentration of the filtrate was maintained at 1 μg/L. Accordingly, it could be confirmed that the iron hydroxide remaining in the filter layer was not stripped off by subsequent water passing.

It was confirmed that, it is possible to add a protrusion required to stabilize water quality of the filtrate to the surface of the solid filter material, by passing the protrusion forming liquid for three hours so as to cause an Fe-concentration of 1 ppm with respect to the water to be treated. It is presumed that a suspended-matter removal ability can be maintained unless iron hydroxide comes out from the filter layer.

According to FIG. 12, the SDI of the filtrate remained high at 5.21 when only the water to be treated was passed through without passing of the protrusion foaming liquid, as with Test B. In Test B, it is presumed that, although suspended matters were removed with mainly an interception effect and diffusion by Brownian motion, medium suspended matters (0.1 μm to 10 μm) could not be removed, preventing a sufficient decrease of the SDI. It is presumed that the SDI was kept high because medium suspended matters have not been removed.

A result of this Study shows that, after passing of the protrusion foaming liquid through the filter layer, the water quality of the filtrate can be improved quickly in two to three hours. Even after the passing of the protrusion foaming liquid was stopped, the water quality of the filtrate was stable.

In sand filtration using a typical flocculant, the flocculant is continuously added. The flocculant and sludge famed by suspended matters contained in the water to be treated cause clogging of a filter layer, increasing a differential pressure along with the continuation of the filtration. Thus, in general, the filter layer must be washed in a washing speed in which a developing rate of air washing (washing by collision between filter materials, using air bubbling) and the filter water becomes 30%. Whereas, in the present filtration method, which injects protrusion foaming liquid to add a protrusion to a surface of a solid filter material, it is only capturing suspended matters contained in water to be treated, reducing a washing frequency of a solid-filter-material layer without increasing a differential pressure.

### (Study 5)

A suspended-mater removal test was performed by using a suspended-matter removing apparatus provided with a coarse-particle separation part (column diameter 5 cm) and a filtering part (column diameter 5 cm).

A sand filtration apparatus was used as the coarse-particle separation part. The sand filtration apparatus has a sand filter layer (length 1200 mm) famed by filling sand with an average particle diameter of 350 μm, and a gravel filter layer (length 100 mm) famed by filling gravel with an average particle diameter of 2000 μm. The sand filter layer is on an upstream side of the gravel filter layer in a passing direction of water to be treated.

The filtering part has a filter layer. The filter layer is configured by an anthracite filter layer (length 200 mm) formed by filling anthracite with an average particle diameter of 700 μm, a sand filter layer (length 1000 mm) formed by filling sand with an average particle diameter of 350 μm, and a gravel filter layer (length 100 mm) formed by filling gravel with an average particle diameter of 2000 μm. The anthracite filter layer, the sand filter layer, and the gravel filter layer are arranged in this order from the upstream side in the passing direction of the water to be treated.

Water to be treated was passed through the coarse-particle separation part by a water-to-be-treated feeding part. Then, filtrate (primarily treated water) that had come out from the coarse-particle separation part was passed through the filtering part. The primarily treated water before entering the filtering part was added with protrusion forming liquid, and the protrusion forming liquid and the primarily treated water were passed in same time. After three hours from the start of passing, the passing of the protrusion forming liquid was stopped. The water to be primarily treated continued to be passed for three hours even after the passing of the protrusion forming liquid was stopped.

Differential pressures of the coarse-particle separation part and the filtering part were measured by a differential-pressure measuring device, during the passing of the water to be treated and the primarily treated water. Additionally, an SDI of liquid (filtrate) that had passed the filtering part was continuously measured. A filtering speed was 10 m/h.

The protrusion element was made of iron chloride (FeCl₃), and the protrusion forming liquid was fed so as to cause an Fe-concentration of 1 ppm with respect to the primarily treated water. An SDI of seawater before passing is 6.28.

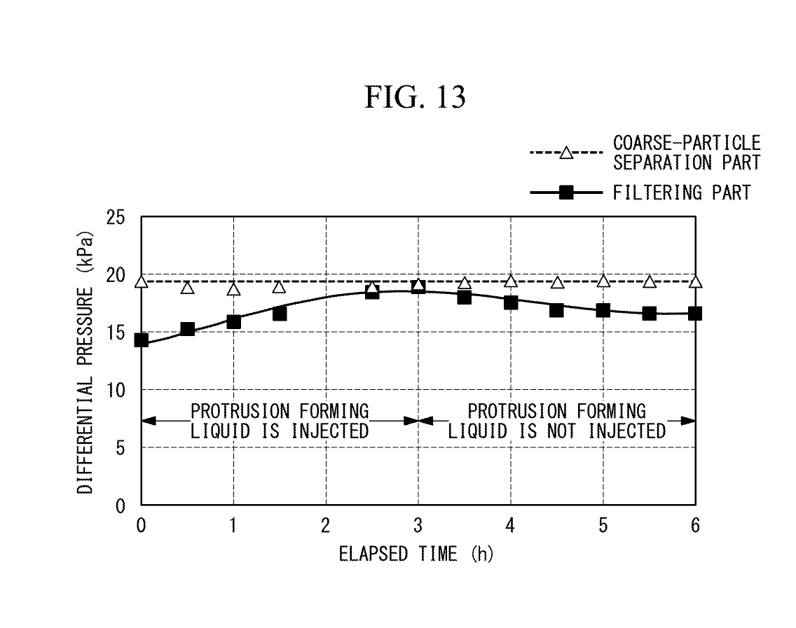

FIG. 13 shows a measurement result of differential pressures of the coarse-particle separation part and the filtering part (filter layer). In this figure, the horizontal axis is an elapsed time (h), and the vertical axis is the differential pressure (kPa). According to FIG. 13, during the passing of the water to be treated, a change in the differential pressure of the filtering part was hardly observed at the coarse-particle separation part. According to FIG. 13, while the differential pressure of the filtering part was slightly increased during the passing of the protrusion forming liquid, an increase in the differential pressure was not observed during the passing of only the primarily treated water after the passing of the protrusion foaming liquid was stopped.

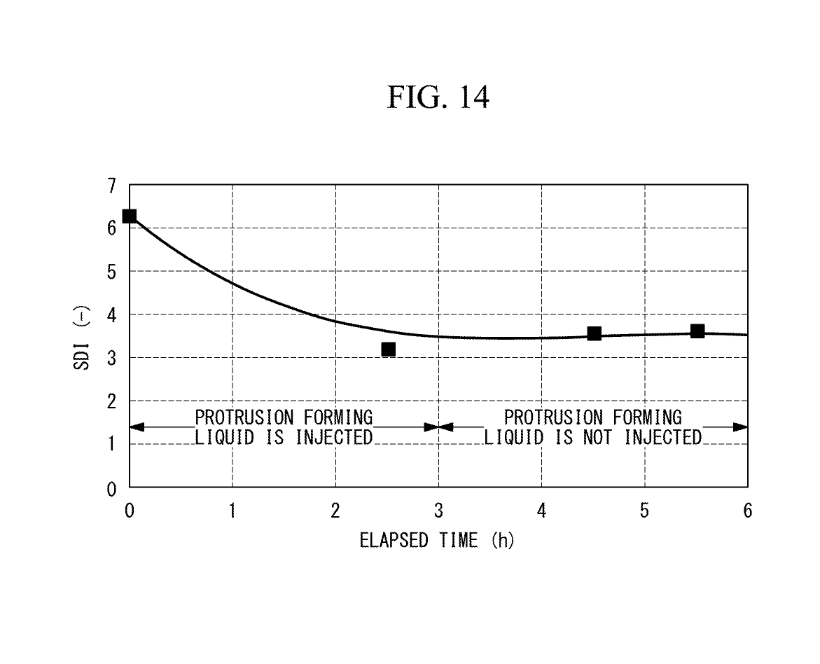

FIG. 14 shows an SDI measurement result of the filtrate that has come out from the filtering part. In this figure, the horizontal axis is an elapsed time (h), and the vertical axis is the SDI (−). According to FIG. 14, although the SDI of seawater before passing was 6 or more, the SDI of the filtrate of the filtering part was decreased to less than 4 after two to three hours of passing of the protrusion forming liquid. The SDI of the filtrate of the filtering part could be maintained at less than 4, even after the passing of the protrusion foaming liquid was stopped. While a standard of a turbidity concentration required for feed water to an RO (reverse osmosis) membrane is generally SDI<4, the filtrate of two to three hours of passing satisfied the water quality standard.

Based on the results of Studies 1 to 3, it is presumed that the coarse-particle separation part mainly captures suspended matters smaller than 0.1 μm, and suspended matters larger than 10 μm. Since the SID has been decreased by passing the primarily treated water from which coarse particles are removed through the filtering part (filtering layer), the filter layer seems to capture medium sized suspended matters of 0.1 μm or more to 10 μm or less.

### (Study 6)

A suspended-mater removal test was performed by using a suspended-matter removing apparatus provided with a coarse-particle separation part (column diameter 5 cm) and a filtering part (column diameter 5 cm). A sand filtration apparatus was used as the coarse-particle separation part. The sand filtration apparatus has a sand filter layer (length 800 mm) famed by filling sand with an average particle diameter of 350 μm, and a gravel filter layer (length 100 mm) formed by filling gravel with an average particle diameter of 2000 μm. The sand filter layer is on an upstream side of the gravel filter layer in a passing direction of water to be treated.

The filtering part has a filter layer. The filter layer is configured by an anthracite filter layer (length 200 mm) famed by filling anthracite with an average particle diameter of 700 μm, a sand filter layer (length 600 mm) famed by filling sand with an average particle diameter of 350 μm, and a gravel filter layer (length 100 mm) formed by filling gravel with an average particle diameter of 2000 μm. The anthracite filter layer, the sand filter layer, and the gravel filter layer are arranged in this order from the upstream side in the passing direction of the water to be treated.

Water to be treated was passed through the coarse-particle separation part by a water-to-be-treated feeding part. Then, filtrate (primarily treated water) that had come out from the coarse-particle separation part was passed through the filtering part. The primarily treated water before entering the filtering part was added with protrusion forming liquid, and the protrusion forming liquid and the primarily treated water were passed in same time. After three hours from the start of passing, the passing of the protrusion foaming liquid was stopped. The primarily treated water continued to be passed through for three hours even after the passing of the protrusion forming liquid was stopped.

Differential pressures of the coarse-particle separation part and the filtering part were measured by a differential-pressure measuring device, during the passing of the water to be treated and the primarily treated water. Additionally, an SDI of liquid (filtrate) that had passed the filtering part was continuously measured. A filtering speed was 10 m/h.

The protrusion element was made of kaolin. As the kaolin, powder with an average particle diameter of 10 to 15 μm was used (made by Takehara Kagaku Kogyo Co., Ltd.). The protrusion foaming liquid was fed to cause a kaolin concentration of 2 ppm with respect to the primarily treated water. An SDI of seawater before passing is 5.2.

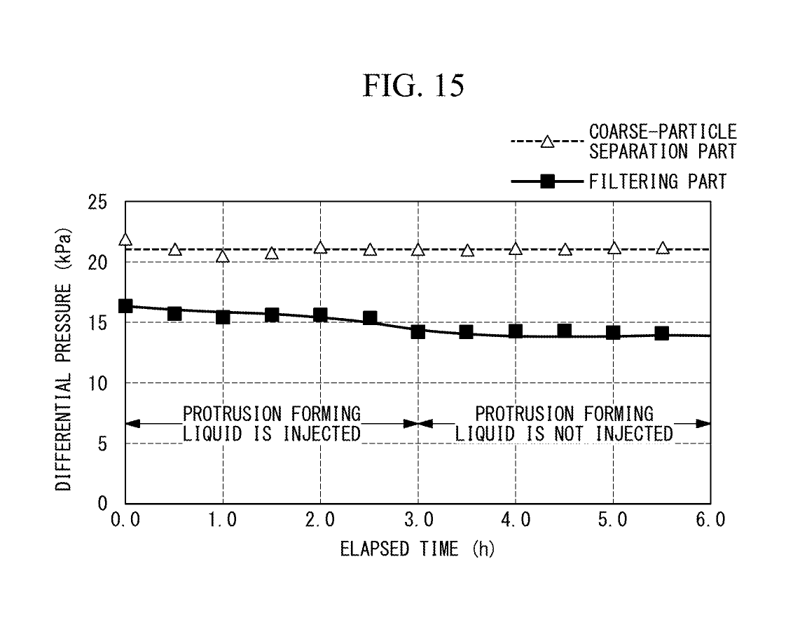

FIG. 15 shows a measurement result of differential pressures of the coarse-particle separation part and the filtering part (filter layer). In this figure, the horizontal axis is an elapsed time (h), and the vertical axis is the differential pressure (kPa). According to FIG. 15, during the passing of the water to be treated, a change in differential pressures of the coarse-particle separation part and the filtering part was hardly observed.

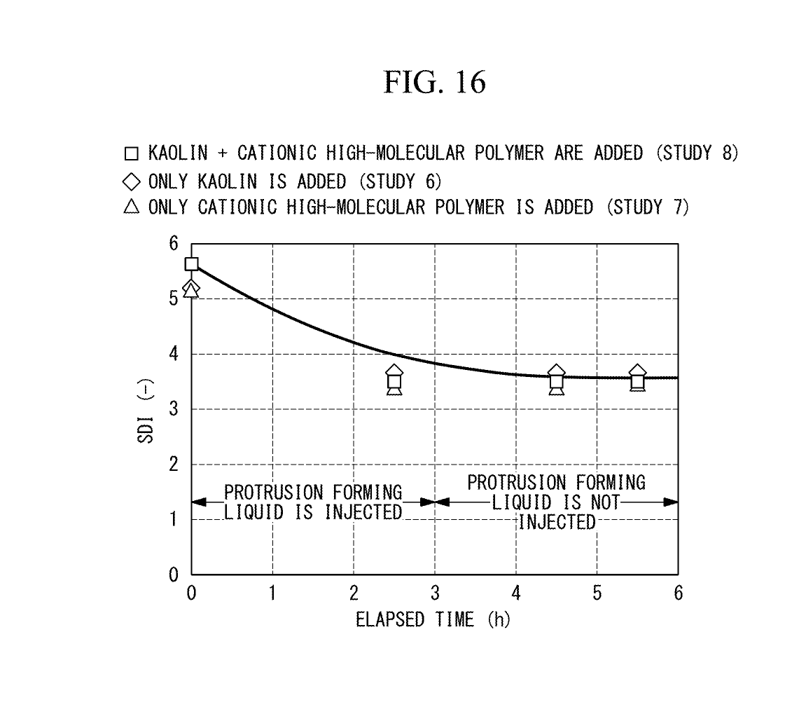

FIG. 16 shows an SDI measurement result of the filtrate that has come out from the filtering part. In this figure, the horizontal axis is an elapsed time (h), and the vertical axis is the SDI (−). According to The FIG. 16, after the passing of the protrusion forming liquid through the filter layer, the SDI of the filtrate quickly fell to below 4. It is presumed that the kaolin is captured to form a protrusion, and the protrusion removes medium sized suspended matters. Here, it was confirmed that an increase in differential pressures of the coarse-particle separation part and the filtering part was small.

As an index that indicates a performance of a filter column, an L/D is used. The L/D is obtained by dividing a layer thickness L by a particle diameter D. The L/D is a value proportional to a total area of the filter material per unit filtration area, and as this value is larger, a surface area of the filter material per unit filtration area is larger. The L/D of this testing apparatus was 4385. The L was calculated from an input amount of kaolin, and the L/D calculated by using a particle diameter of 12.5 μm (an arithmetic average of an average particle diameter) was 0.4. Thus, it is found that SDI<4 can be satisfied without an increase of the surface area.

### (Study 7)

Protrusion foaming liquid containing high-molecular polymer as a protrusion element was fed to primarily treated water, and a differential pressure of a filtering part and an SDI of filtrate of the filtering part were measured, as with (Study 6) above. A filtering speed was 10 m/h.

A solid filter material and a filter layer are same as those in (Study 6) above. As the high-molecular polymer, there was used Himoloc Q707 (polyamide based, molecular weight (estimate)=70,000, specific gravity=1.15) made by HYMO CORPORATION. The protrusion forming liquid was fed so as to cause a high-molecular polymer concentration of 0.5 ppm with respect to the primarily treated water. The water to be treated is Seawater. An SDI of the seawater before passing was 5.2.

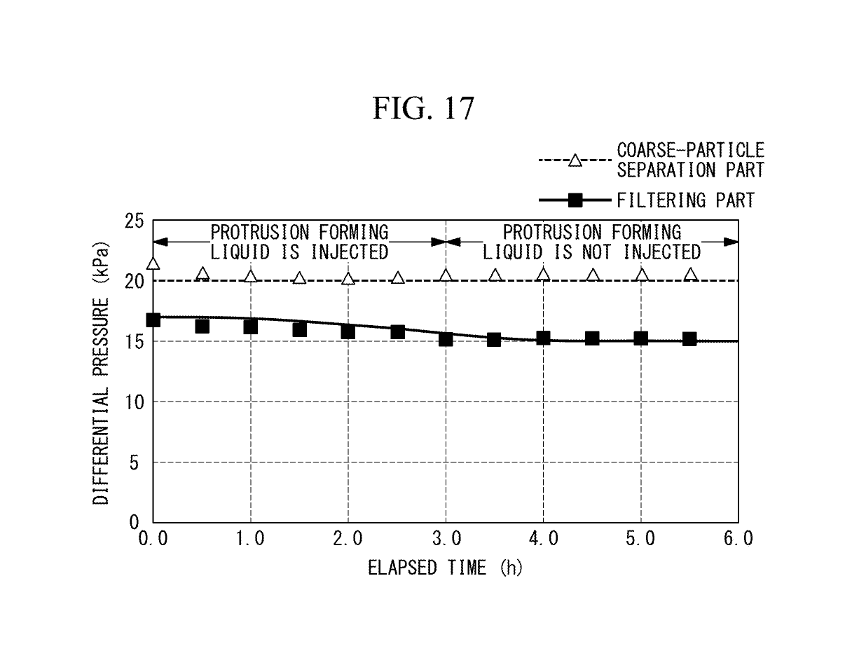

FIG. 17 shows a measurement result of differential pressures of a coarse-particle separation part and the filtering part (filter layer). In this figure, the horizontal axis is an elapsed time (h), and the vertical axis is the differential pressure (kPa) of the filter layer. According to FIG. 17, during the passing of the water to be treated, a change in differential pressures of the coarse-particle separation part and the filtering part was hardly observed.

FIG. 16 shows an SDI measurement result of the filtrate that has come out from the filtering part. According to FIG. 16, although the SDI of seawater was 5.2, the SDI of the filtrate of the filtering part was decreased to less than 4 after two to three hours of passing of the protrusion forming liquid. The SDI of the filtrate of the filtering part could be maintained at less than 4, even after the passing of the protrusion forming liquid was stopped. It was considered that the high-molecular polymer had utilized suspended matters in the seawater to form a protrusion on the surface of the solid filter material, causing a decrease in the SDI. Here, it was confirmed that an increase in differential pressures of the coarse-particle separation part and the filtering part was small.

### (Study 8)

Protrusion forming liquid containing kaolin and high-molecular polymer as a protrusion element was fed to primarily treated water, and a differential pressure of the filtering part and an SDI of the filtrate of the filtering part were measured, as with (Study 6) above. A filtering speed was 10 m/h.

A solid filter material and a filter layer are same as those in (Study 6) above. As the kaolin, powder with an average particle diameter of 10 to 15 μm was used (made by Takehara Kagaku Kogyo Co., Ltd.). As the high-molecular polymer, there was used Himoloc Q707 (polyamide based, molecular weight (estimate)=70,000, specific gravity=1.15) made by HYMO CORPORATION. The protrusion foaming liquid was fed so as to cause kaolin of 2 ppm and high-molecular polymer of 0.5 ppm with respect to the primarily treated water. The water to be treated is Seawater. An SDI of the seawater before passing was 5.6.

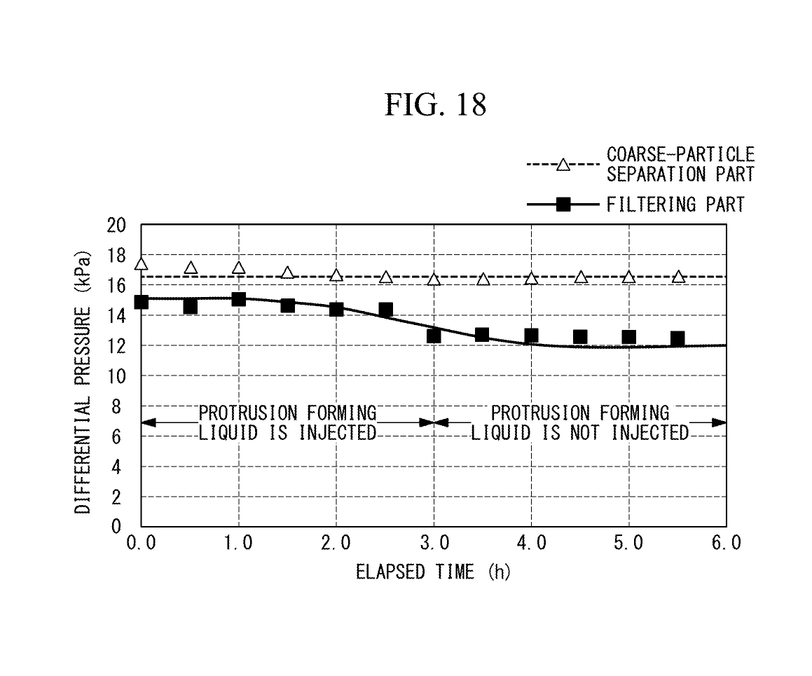

FIG. 18 shows a measurement result of the differential pressures of the coarse-particle separation part and the filtering part (filter layer). In this figure, the horizontal axis is an elapsed time (h), and the vertical axis is the differential pressure (kPa) of the filter layer. According to FIG. 18, during the passing of the water to be treated, a change in the differential pressure of the filtering part was hardly observed at the coarse-particle separation part. According to FIG. 18, during the passing of the protrusion foaming liquid, the differential pressure of the filtering part was not increased, and even after the passing of the protrusion foaming liquid was stopped, the differential pressure of the filtering part was not increased.

FIG. 16 shows an SDI measurement result of the filtrate that has come out from the filtering part. According to FIG. 16, although the SDI of the seawater before passing was 5.6 or more, the SDI of the filtrate of the filtering part was decreased to less than 4 after two to three hours of passing of the protrusion forming liquid. The SDI of the filtrate of the filtering part could be maintained at less than 4, even after the passing of the protrusion foaming liquid was stopped. It was presumed that the kaolin and the high-molecular polymer formed a protrusion on the surface of the solid filter material, causing a decrease the SDI.

### REFERENCE SIGNS LIST

1, 11, 21 suspended-matter removing apparatus

2 filtering part

2a filter layer

2b first opening

2c second opening

3 water-to-be-treated feeding part

3a water-to-be-treated tank

3b first feeding means

4 protrusion-element feeding part

4a protrusion element tank

4b second feeding means

5, 15 determination part

6, 16 control part

7 first passage

8 second passage

9 water-quality inspection means

10 reverse-osmosis-membrane treatment part

12 differential-pressure measurement part

22 coarse-particle separation part

1. A suspended-matter removing method comprising the steps of:
by feeding a protrusion element to a filter layer formed by filling a solid filter material, adding a protrusion to a surface of the solid filter material;
after feeding of the protrusion element in the step of adding a protrusion, determining whether or not a protrusion satisfying a preset standard has been added to the surface of the solid filter material, and when it is determined that the protrusion has been added, reducing a feeding amount of the protrusion element as compared with when adding the protrusion; and
passing water to be treated containing suspended matters through the filter layer having the solid filter material added with the protrusion in a state in which the feeding amount of the protrusion element is reduced.

2. The suspended-matter removing method according to claim 1, wherein the feeding of the protrusion element is stopped, in the step of reducing the feeding amount of the protrusion element.

3. The suspended-matter removing method according to claim 1, further comprising a step of passing the water to be treated through the filter layer, in parallel with the step of adding a protrusion.

4. The suspended-matter removing method according to claim 1, further comprising a step of measuring a differential pressure between a first side of the filter layer and a second side of the filter layer, wherein
the protrusion element is fed within a range where the measured differential pressure is less than a predetermined value, in the step of adding a protrusion.

5. The suspended-matter removing method according to claim 1, further comprising a step of directly or indirectly measuring an amount of the protrusion element contained in filtrate that has come out from the filter layer in the step of adding the protrusion, wherein
it is determined that the protrusion satisfying the preset standard has been added to the surface of the solid filter material when the measured amount of the protrusion element becomes equal to or less than a preset threshold value.

6. The suspended-matter removing method according to claim 1, wherein
a total feeding amount of the protrusion element to the filter layer in the step of adding a protrusion is counted, and it is determined that the protrusion satisfying the preset standard has been added to the surface of the solid filter material when the counted total feeding amount reaches a preset threshold value.

7. The suspended-matter removing method according to claim 1, further comprising a step of inspecting water quality of the filtrate that has come out from the filter layer in the step of passing the water to be treated, wherein
when an inspection value of the filtrate exceeds a preset threshold value, it is determined that the protrusion satisfying the preset standard has not been added to the surface of the solid filter material, and the step of adding a protrusion is performed; and when the inspection value of the filtrate is equal to or less than the preset threshold value, it is determined that the protrusion satisfying the preset standard has been added to the surface of the solid filter material, and the feeding amount of the protrusion element is reduced as compared with when adding the protrusion.

8. The suspended-matter removing method according to claim 1, wherein
in the step of passing the water to be treated, the water to be treated is passed through a coarse-particle separation part to make the water to be treated into primarily treated water by mainly separating suspended matters larger than 10 μm contained in the water to be treated, and then the primarily treated water is passed through the filter layer to remove suspended matters having a size of 0.1 μm or more to 10 μm or less.

9. The suspended-matter removing method according to claim 1, wherein a height of the protrusion is 4 μm or more.

10. The suspended-matter removing method according to claim 1, wherein an average particle diameter of the solid filter material is 300 μm or more to 2500 μm or less.

11. The suspended-matter removing method according to claim 1, wherein the protrusion element is made of kaolin.

12. The suspended-matter removing method according to claim 1, wherein the protrusion element is made of iron chloride.

13. The suspended-matter removing method according to claim 12, wherein, in the step of reducing the feeding amount of the protrusion element as compared with when the protrusion is added, the feeding amount of the protrusion element is reduced such that content of the protrusion element becomes less than 0.5 ppm as iron in a solution that passes the filter layer.

14. The suspended-matter removing method according to claim 1, wherein the protrusion element is made of high-molecular polymer.

15. A suspended-matter removing apparatus comprising:
a filtering part having a filter layer formed by filling a solid filter material;
a water-to-be-treated feeding part that feeds water to be treated to a first side of the filtering part to pass the water to be treated through the filter layer;
a protrusion-element feeding part that feeds a protrusion element to the first side of the filtering part;
a determination part that, based on a preset standard, determines whether or not a protrusion has been added to a surface of the solid filter material; and
a control part that, when the determination part determines that the protrusion has been added, controls the protrusion-element feeding part to reduce a feeding amount of the protrusion element as compared with when it is determined that the protrusion has not been added.

16. The suspended-matter removing apparatus according to claim 15, wherein, the control part is set to control the protrusion-element feeding part to stop feeding of the protrusion element, when the determination part determines that the protrusion has been added.

17. The suspended-matter removing apparatus according to claim 15, further comprising a differential-pressure measurement part that measures a differential pressure between the first side and a second side of the filtering part, and the control part is set to control the feeding amount of the protrusion element from the protrusion-element feeding part such that the differential pressure measured by the differential-pressure measurement part becomes less than a predetermined value.
